(19) United States
(12) Patent Application Publication
(10) Pub. No.: US 2026/0045647 A1
(43) Pub. Date: Feb. 12, 2026

(54) Battery Cell and Battery Module Including the Same

(71) Applicant: LG Energy Solution, Ltd., Seoul (KR)

(72) Inventor: Jong Cheol Lee, Daejeon (KR)

(73) Assignee: LG Energy Solution, Ltd., Seoul (KR)

(21) Appl. No.: 18/855,057

(22) PCT Filed: Dec. 20, 2023
(86) PCT No.: PCT/KR2023/021046

§ 371 Date: Oct. 8, 2024

(30) Foreign Application Priority Data
Dec. 20, 2022 (KR) 10-2022-0179117
Dec. 19, 2023 (KR) 10-2023-0185647

(51) Int. Cl. H01M 50/507; H01M 50/105; H01M 50/178; H01M 50/186; H01M 50/211; H01M 50/516; H01M 50/517

(52) U.S. Cl. CPC H01M 50/507; H01M 50/105; H01M 50/178; H01M 50/186; H01M 50/211; H01M 50/516; H01M 50/517

(57) ABSTRACT

A battery cell includes an electrode assembly and a pouch case. The electrode assembly includes electrodes and a separator located between the electrodes and the pouch case has an outer peripheral side sealed in a state where the electrode assembly is housed inside. The electrode includes an electrode current collector with an active material layer formed on one side or both sides of the electrode current collector and a protrusion formed such that a part of the electrode current collector protrudes to the outside of the sealed pouch case. A busbar is joined to the protrusion.

### CROSS-REFERENCE TO RELATED APPLICATION(S)

The present application is a national phase entry under 35 U.S. C. § 371 of International Application No. PCT/KR2023/021046, filed on Dec. 20, 2023, which claims priority from Korean Patent Application No. 10-2022-0179117, filed on Dec. 20, 2022, and Korean Patent Application No. 10-2023-0185647, filed on Dec. 19, 2023, all of which are incorporated herein by reference.

### TECHNICAL FIELD

The present disclosure relates to a battery cell and a battery module including the same, and more specifically, to a pouch-type battery cell and a battery module including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of the secondary battery is growing.

Depending on the shape of the exterior material, generally, a lithium secondary battery may be classified into a can type secondary battery where the electrode assembly is incorporated into a metal can and a pouch type battery where the electrode assembly is incorporated into a pouch of an aluminum laminate sheet.

In the case of a secondary battery used for small-sized devices, two to three battery cells are disposed, but in the case of a secondary battery used for a medium-and large-sized device such as automobiles, a battery module in which a plurality of battery cells are electrically connected is used. In such a battery module, a plurality of battery cells are connected to each other in series or parallel to form a cell assembly, thereby improving capacity and output. Further, one or more battery modules can be mounted together with various control and protection systems such as a BDU (battery disconnect unit), a BMS (battery management system), and a cooling system to form a battery pack.

In a conventional battery module, a busbar and a busbar frame can be utilized for electrical connections between multiple battery cells. Below, the structure of the busbar and the busbar frame used in a conventional battery module will be described with reference to FIGS. 1 and 2.

FIG. 1 is a perspective view illustrating a conventional battery module. FIG. 2 is a partial view which enlarges and illustrates a section “A” of FIG. 1. In particular, FIG. 1 illustrates a state in which battery modules stand upright to show the appearance of the busbar frame and busbar. FIG. 3 is a cross-sectional view for explaining a connection configuration between an electrode tab and an electrode lead inside a battery cell in a conventional battery module.

Referring to FIGS. 1 to 3, the conventional battery module 10 includes a battery cell stack 12 in which a plurality of battery cells 11 are stacked, and busbar frames 30 arranged on both sides of the battery cell stack 12. A busbar 40 may be mounted on such busbar frames 30.

The busbar 40 is for electrical connection between the plurality of battery cells 11, and the electrode lead 11L of the battery cell 11 passes through a slit formed in the busbar frame 30 and then can be bent and connected to the busbar 40. In some cases, the electrode lead 11L may also pass through a slit 40S formed in the busbar 40.

The method for performing connection between the electrode lead 11L and the busbar 40 is not limited as long as electrical connection is possible, and as an example, the connection may be made by weld-joining. The battery cells 11 can be electrically connected in series or in parallel via the busbar 40.

The battery cell 11 can be produced by housing the electrode assembly 11A inside a pouch-type cell case 11C and then sealing the outer peripheral side of the cell case 11C to form a sealing portion 11S. The electrode assembly 11A may include electrodes and a separator disposed between the electrodes. Each electrode includes electrode tabs 11t, wherein the electrode tabs 11t can be connected to the electrode lead 11L by a method such as welding. More specifically, the electrode includes an electrode current collector made of a metal material and an electrode active material layer formed by coating an electrode active material onto one side or both sides of the electrode current collector. A part of such an electrode current collector may be extended to form an electrode tab 11t. When sealing the outer peripheral side of the cell case 11C to form the sealing portion 11S, the lead film 11F surrounding the electrode lead 11L may be interposed between the sealing portions 11S in order to improve sealing performance and secure electrical insulation.

The electrode lead 11L protrudes to the outside of the cell case 11C, passes through the slit 30S of the busbar frame 30 and the slit 40S of the busbar 40, and then can be bent and connected to the busbar 40.

In the case of the conventional battery cell 11, the electrode tabs 11t are pre-welded with each other, the electrode tabs 11t are then welded to the electrode lead 11L, and the electrode lead 11L is welded to the busbar 40. Welding resistance between the electrode tabs 11t, welding resistance between the electrode tab 11t and the electrode lead 11L, and welding resistance between the electrode lead 11L and the busbar 40, that is, welding resistance at three locations in total may occur.

The resistance of the battery cell 11 is a factor that affects not only the heat generation of the battery cell 11 but also the voltage measurement. Recently, in battery modules that require high output, whether or not the correct voltage is measured to guarantee the output range is a major management subject together with the heat generation of the battery cell 11. Therefore, there is a need to develop a technology that can reduce internal resistance in the structure of battery cells and battery modules including the same.

### SUMMARY

### Technical Problem

It is an object of the present disclosure to provide a battery cell that can reduce internal resistance and a battery module including the same.

However, the technical problems to be solved by aspects of the present disclosure are not limited to the above-mentioned problems, and can be variously expanded within the scope of the technical idea included in the present disclosure.

### Technical Solution

According to one aspect of the present disclosure, there is provided a battery cell comprising: an electrode assembly including electrodes and a separator located between the electrodes; and a pouch case whose outer peripheral side is sealed in a state where the electrode assembly is housed inside, wherein the electrode includes an electrode current collector and an active material layer formed on one side or both sides of the electrode current collector, wherein the electrode current collector includes a protrusion formed such that a part of the electrode current collector protrudes to the outside of the sealed pouch case, and wherein a busbar is joined to the protrusion.

The protrusion and the busbar may be welded and joined.

The outer peripheral side of the pouch case may be sealed in a state where the protrusion is joined to the busbar.

The outer peripheral side of the pouch case may be sealed to form a sealing portion, and a film surrounding the protrusion may be interposed between the sealing portions.

The film may surround up to the portion where the protrusion is exposed to the outside of the sealing portion.

The film may surround a portion where the protrusion is joined to the busbar and at least a partial area of the busbar.

According to another aspect of the present disclosure, there is provided a battery module comprising: a battery cell stack in which the battery cells are stacked, wherein the busbars are connected with each other by a mechanical fastening method, so that an electric connection between the battery cells is performed.

The mechanical fastening method may be a bolt fastening, a rivet fastening, a clinching fastening, or a fitting coupling.

In the battery cell stack, the battery cells may be stacked along one direction so that one side surfaces face each other.

The battery module may comprise a connection busbar that connects the busbars.

The connection busbar may be connected to at least two of the busbars by a mechanical fastening method.

A through hole may be formed in each of the busbar and the connection busbar, and the bolt member passes through the through hole of the busbar and the through hole of the connection busbar and then can be fastened to a nut member.

A through hole may be formed in each of the busbar and the connection busbar, and a rivet member may fasten the through hole of the busbar and the through hole of the connection busbar.

The busbar and the connection busbar may be connected to each other by a clinching fastening method.

The busbar and the connection busbar may be configured such that an insertion groove is formed in any one of the busbar and the connection busbar, and the busbar and the connection busbar may be connected to each other while the other one of the busbar and the connection busbar is fitted into the insertion groove.

The connection busbar may be a bar-shaped metal member or a metal member having a bending portion.

The protrusions of at least two of the battery cells may be joined to one of the busbars.

At least one busbar frame may be arranged on one side or both sides of the battery cell stack, and the busbar frame may be located between the busbar and the battery cell stack.

### Advantageous Effects

According to aspects of the present disclosure, resistance during the electrical connection process of the battery cells can be reduced through a battery cell-busbar integrated structure in which the electrode current collector within the electrode is directly joined to the busbar. Accordingly, it is possible to reduce voltage measurement errors in high-output battery modules and reduce heat generation of battery cells during charging and discharging.

Meanwhile, a mechanical fastening structure is applied to connection between busbars in the battery module, thereby increasing the degree of freedom in design. In addition, the mechanical fastening structure is easier to rework than welding, and does not need to worry about loss due to defective welding.

Effects obtainable from the present disclosure are not limited to the effects mentioned above, and additional other effects not mentioned herein will be clearly understood from the description of the appended claims by those skilled in the art.

### BRIEF DESCRIPTION OF THE DRAWINGS

FIG. 1 is a perspective view illustrating a conventional battery module.

FIG. 2 is a partial view which enlarges and illustrates a section “A” of FIG. 1.

FIG. 3 is a cross-sectional view for explaining a connection configuration between an electrode tab and an electrode lead inside a battery cell in a conventional battery module.

FIG. 4 is an exploded perspective view illustrating a battery module according to an aspect of the present disclosure.

FIG. 5 is a plan view illustrating one of the battery cells included in the battery module of FIG. 4.

FIG. 6 is a cross-sectional view illustrating a cross section taken along the cutting line B-B′ of FIG. 5.

FIG. 7 is a partial perspective view which enlarges and illustrates the battery cell stack and busbar portion included in the battery module of FIG. 4.

FIG. 8 is a partial perspective view for explaining the bolt fastening structure between a busbar and a connection busbar according to an aspect of the present disclosure.

FIG. 9 is a perspective view illustrating a busbar frame according to an aspect of the present disclosure.

FIG. 10 is a front view illustrating a busbar frame according to another aspect of the present disclosure.

FIG. 11 is a front view schematically illustrating a busbar, a connection busbar, and a busbar frame according to an aspect of the present disclosure.

FIGS. 12 and 13 are cross-sectional views of the battery cells according to other aspects of the present disclosure, respectively.

FIGS. 14 and 15 are perspective views illustrating a rivet fastening method among mechanical fastening methods according to aspects of the present disclosure.

FIG. 16 is a cross-sectional view taken along the cutting line C-C′ of FIG. 15.

FIG. 17 is a perspective view illustrating the clinching fastening method among the mechanical fastening methods according to aspects of the present disclosure.

FIG. 18 is a cross-sectional view taken along the cutting line D-D′ of FIG. 17.

FIG. 19 (a) and (b) are cross-sectional views for explaining the fitting coupling among the mechanical fastening method according to aspects of the present disclosure.

FIG. 20 is a partial perspective view which enlarges and illustrates the battery cell stack and busbar portion according to another aspect of the present disclosure.

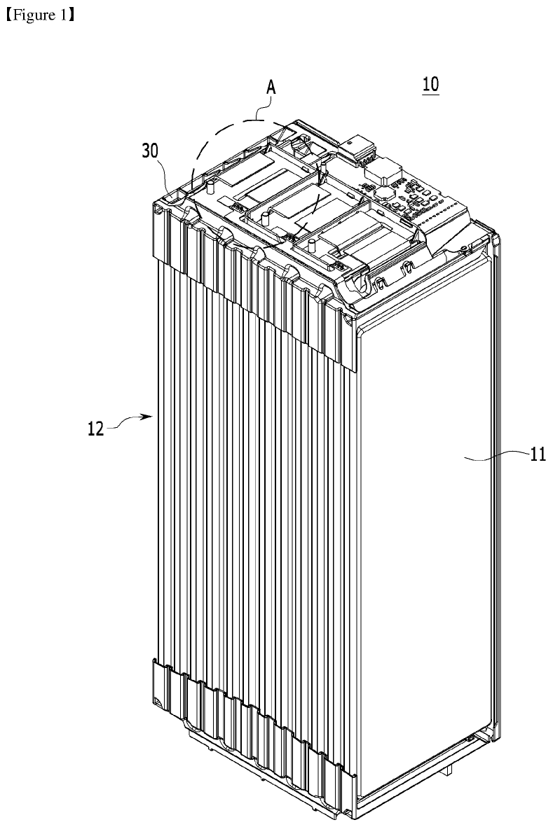

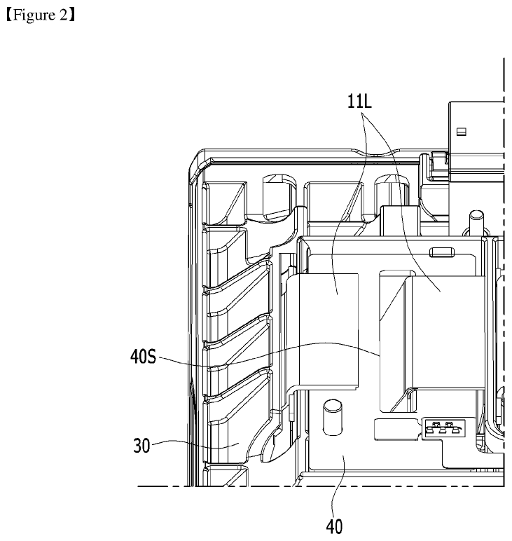

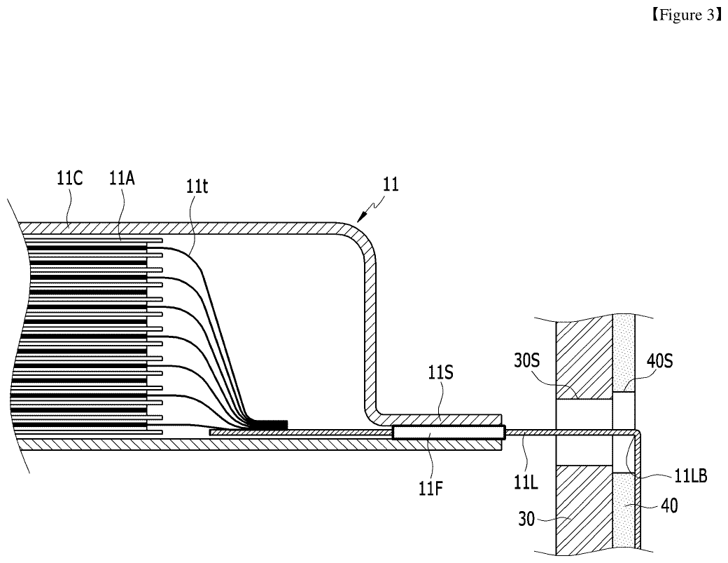

### [DETAILED DESCRIPTION]

Hereinafter, various aspects of the present disclosure will be described in detail with reference to the accompanying drawings so that those skilled in the art can easily carry out them. The present disclosure may be modified in various different ways, and is not limited to the aspects set forth herein.

A description of portions that are not related to the description will be omitted for clarity, and same reference numerals designate same or like elements throughout the description.

Further, in the drawings, the size and thickness of each element are arbitrarily illustrated for convenience of description, and the present disclosure is not necessarily limited to those illustrated in the drawings. In the drawings, the thickness of layers, areas, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain portion being located “above” or “on” a reference portion means the certain portion being located above or below the reference portion and does not particularly mean the certain portion “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when it is referred to as “cross-sectional”, it means when a target portion is viewed from the side of a cross section cut vertically.

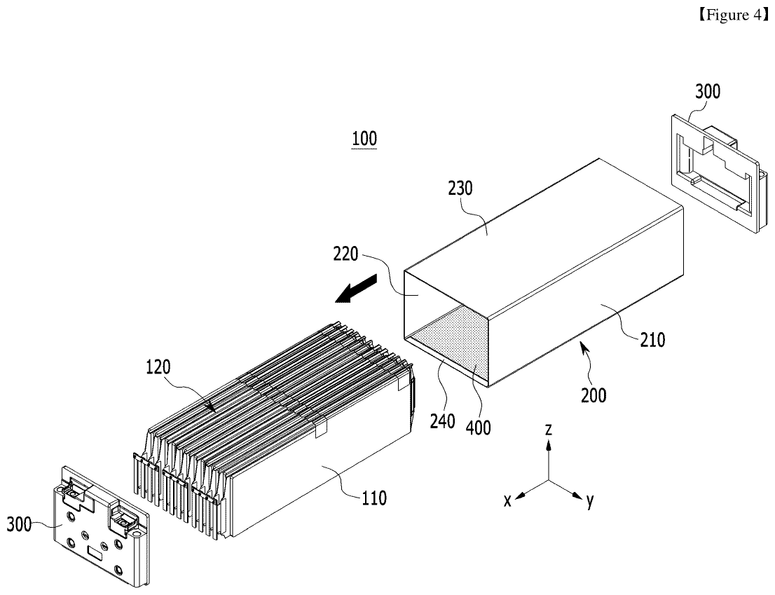

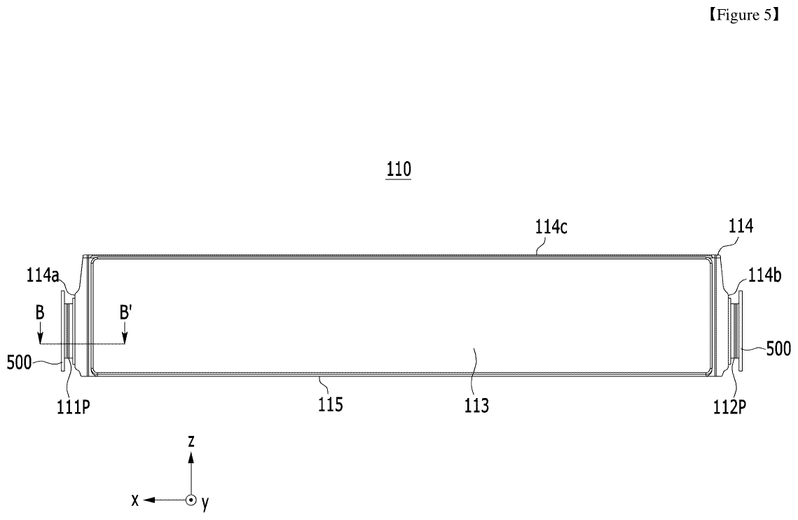

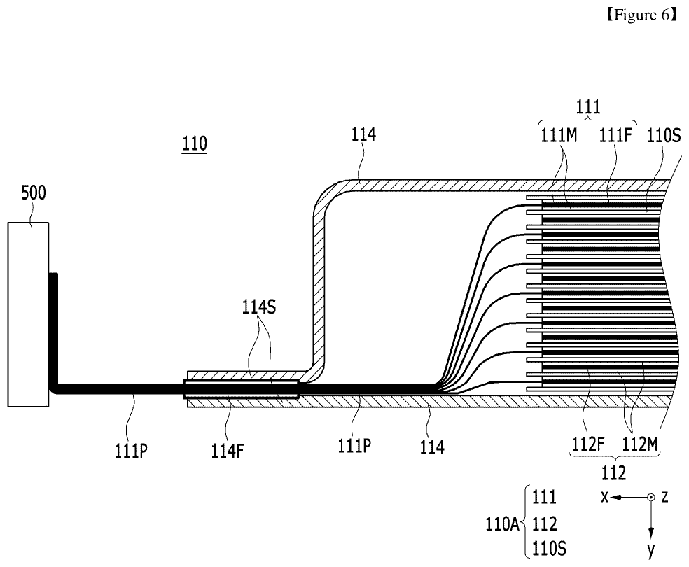

FIG. 4 is an exploded perspective view illustrating a battery module according to an aspect of the present disclosure. FIG. 5 is a plan view illustrating one of the battery cells included in the battery module of FIG. 4. FIG. 6 is a cross-sectional view illustrating a cross section taken along the cutting line B-B′ of FIG. 5.

Referring to FIGS. 4 to 6, the battery module 100 according to an aspect of the present disclosure includes a battery cell stack 120 in which a plurality of battery cells 110 are stacked. First, the battery cell 110 included in the battery cell stack 120 according to the present aspect will be described in detail.

A battery cell 110 according to the present aspect comprises an electrode assembly 110A including electrodes 111 and 112 and a separator 110S located between the electrodes 111 and 112; and a pouch case 114 whose outer peripheral side is sealed in a state where the electrode assembly 110A is housed inside. That is, the battery cell 110 according to the present aspect is a pouch-type battery cell, and may have a rectangular sheet shape.

Each of the electrodes 111 and 112 includes electrode current collectors 111F and 112F, and active material layers 111M and 112M formed on one side or both sides of the electrode current collectors 111F and 112F. The electrodes 111 and 112 include a positive electrode 111 and a negative electrode 112. More specifically, the positive electrode 111 may include a positive electrode current collector 111F and a positive electrode active material layer 111M formed by coating a positive active material onto one side or both sides of the positive electrode current collector 111F, and the negative electrode 112 may include a negative electrode current collector 112F and a negative electrode active material layer 112M formed by coating a negative electrode active material onto one side or both sides of the negative electrode current collector 112F. The separator 110S is interposed between the positive electrode 111 and the negative electrode 112 to block contact between the positive electrode 111 and the negative electrode 112.

The battery cell 110 may be formed by housing an electrode assembly 110A in a pouch case 114 made of a laminate sheet including a resin layer and a metal layer, and then adhering the outer peripheral side of the pouch case 114. Specifically, the battery cell 110 may be produced by adhering both ends 114a and 114b of a pouch case 114 and one side portion 114c connecting them in a state in which an electrode assembly 110A is housed in a pouch case 114. In other words, the battery cell 110 according to an aspect of the present disclosure has a total of three sealing portions 114S, wherein the sealing portions 114S have a structure that is sealed by adhesion between the inner resin layers, which will be described later, and the remaining other one side portion may be composed of a folding portion 115.

The pouch case 114 of the laminate sheet may include an inner resin layer for sealing, a metal layer that prevents penetration of materials, and an outer resin layer located at the outermost side. On the basis of the electrode assembly inside the pouch case 114, the inner resin layer may be located at the innermost side, the outer resin layer may be located at the outermost side, and the metal layer may be located between the inner resin layer and the outer resin layer.

The outer resin layer has excellent tensile strength and weather resistance relative to the thickness and can have electrical insulation properties in order to protect the electrode assembly from the outside. Such an outer resin layer may include a polyethylene terephthalate (PET) resin or a nylon resin. The metal layer can prevent air, moisture, and the like from flowing into the pouch-type secondary battery. Such a metal layer may include aluminum (Al). The inner resin layers may be thermally welded to each other by heat and/or pressure applied in a state where the electrode assembly is embedded therein. This inner resin layer may include casted polypropylene (CPP) or polypropylene (PP).

The pouch case 114 is divided into two portions, and a concave-shaped housing portion in which the electrode assembly can be seated may be formed in at least one of the two portions. Along the outer periphery of this housing portion, the inner resin layers of the two portions of the pouch case 114 may be joined with each other to provide a sealing portion 114S. Heat and/or pressure may be applied to join the inner resin layers together. By sealing the pouch case 114 in this manner, the pouch-type battery cell 110 can be produced.

The battery cell 110 is configured in plural numbers, and a plurality of battery cells 110 are stacked so that they can be electrically connected to each other, thereby forming a battery cell stack 120. In particular, as illustrated in FIG. 4, the plurality of battery cells 110 can be stacked in a direction parallel to the y-axis while standing upright so that one side surfaces of the cell bodies 113 (see FIG. 5) faces each other.

Meanwhile, the electrode current collectors 111F and 112F according to the present aspect include protrusions 111P and 112P formed such that a part of the electrode current collectors 111F and 112F protrudes to the outside of the sealed pouch case 114. That is, a part of the electrode current collectors 111F and 112F extends to form the protrusions 111P and 112P, and such protrusions 111P and 112P may protrude to the outside beyond the sealing portion 114S of the pouch case 114.

In FIG. 6, only the protrusion 111P formed by extending a part of the positive electrode current collector 111F is illustrated, but a part of the negative electrode current collector 112F may extend in the opposite direction to form a protrusion 112P. Thereby, as illustrated in FIG. 5, the protrusion 111P extending from the positive electrode current collector 111F in the battery cell 110 may protrude toward the x-axis direction, and the protrusion 112P extending from the negative electrode current collector 112F may protrude toward the-x-axis direction.

A busbar 500 is joined to such protrusions 111P and 112P. Specifically, the protrusions 111P and 112P and the busbar 500 may be welded and joined. That is, in the case of the battery cell 110 according to the present aspect, the protrusions 111P and 112P formed by extending the electrode current collectors 111F and 112F can be joined directly to the busbar 500, thereby forming a battery cell-busbar integrated structure. In particular, in a state where the protrusions 111P and 112P extending from the electrode current collectors 111F and 112F are joined to the busbar 500, the electrode assembly 110A may be housed in a pouch case 114, and the outer peripheral side of the pouch case 114 may be sealed to form a sealing portion 114S. In order to improve sealing performance and ensure electrical insulation, a film 114F surrounding the protrusions 111P and 112P may be interposed between the sealing portions 114S. Such a film 114F is a material that has electrical insulation and joining performance, and may include one or more materials selected from the group consisting of polyimide (PI), polypropylene (PP), polyethylene (PE), and polyethylene terephthalate (PET).

Unlike the conventional battery cell 11 in which the electrode lead 11L is used, the battery cell 110 according to the present aspect has minimized the area where weld-joining is performed, by joining the protrusions 111P and 112P, which are formed by extending the electrode current collectors 111F and 112F, directly to the busbar 500. That is, by eliminating the electrode lead 11L, welding resistance during the process of realizing electrical connection between the battery cells 110 included in the battery module 100 can be reduced. As much as the internal resistance is reduced, the voltage measurement error in the high-output battery module 100 can be reduced, and the heat generated by the battery cells 110 during charging and discharging can be reduced.

Next, the structure of the busbar and the connection busbar according to the present aspect will be described in detail.

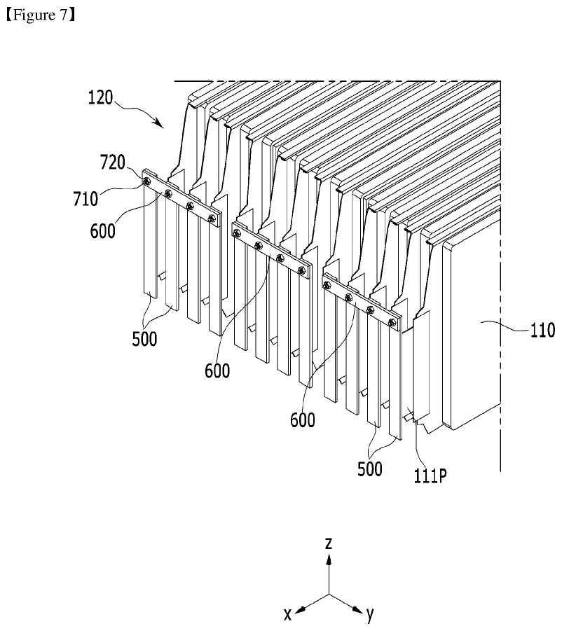

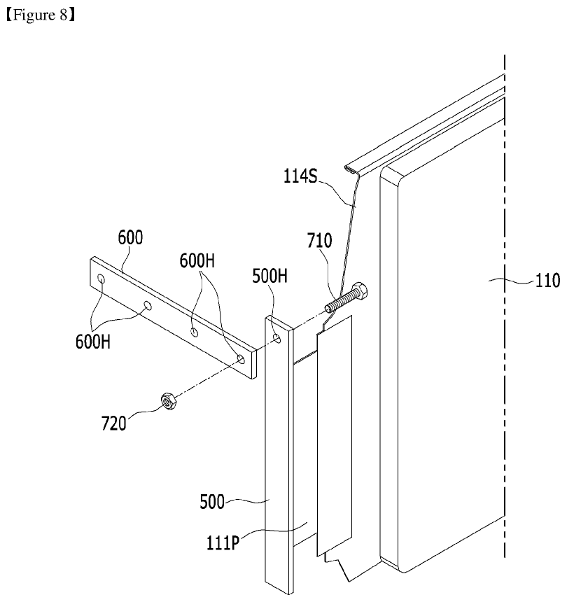

FIG. 7 is a partial perspective view which enlarges and illustrates the battery cell stack and busbar portion included in the battery module of FIG. 4. FIG. 8 is a partial perspective view for explaining the bolt fastening structure between a busbar and a connection busbar according to an aspect of the present disclosure.

Referring to FIGS. 4 and 6 to 8 together, the battery module 100 according to the present aspect includes a battery cell stack 120 in which a plurality of battery cells 110 are stacked, wherein the busbars 500 are connected with each other using a mechanical fastening method to perform electrical connection between the battery cells 110. Here, the mechanical fastening method refers to a fastening method using physical constraint force, rather than a method that uses weld-joining, adhesives or the like. The mechanical fastening method applied in the present disclosure is not particularly limited as long as electrical connection between the busbars 500 is possible.

For example, the mechanical fastening method according to the present aspect may be a bolt fastening, a rivet fastening, a clinching fastening, or a fitting coupling. First, as an example of the mechanical fastening method of the present disclosure, the bolt fastening method will be described.

As described above, in the battery cell stack 120, the battery cells 110 may be stacked along one direction so that one side surfaces face each other. FIG. 4 illustrates a state in which the plurality of battery cells 110 are stacked in a direction parallel to the y-axis while standing upright so that one side surfaces of the cell bodies 113 (see FIG. 5) face each other.

At this time, the busbar 500 is joined to the protrusions 111P and 112P to form a battery cell-busbar integrated structure, as described above. The battery module 100 may further include a connection busbar 600 that connects the busbars 500. Both the busbar 500 and the connection busbar 600 may include a metal material having high electrical conductivity.

The connection busbar 600 may be connected to at least two busbars 500 by a mechanical fastening method. As an example of the mechanical fastening method, the connection busbar 600 may be connected to at least two busbars 500 by bolt fastening. As an example, a through hole 500H may be formed in the busbar 500, and a through hole 600H may also be formed in the connection busbar 600. The bolt member 710 passes through the through hole 500H of the busbar 500 and the through hole 600H of the connection busbar 600, and then can be fastened to a nut member 720.

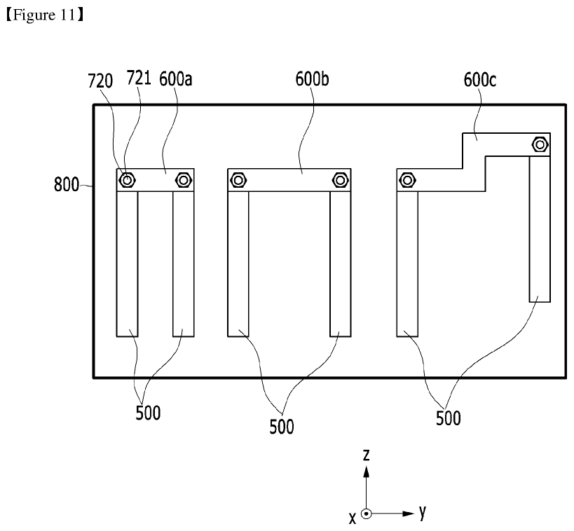

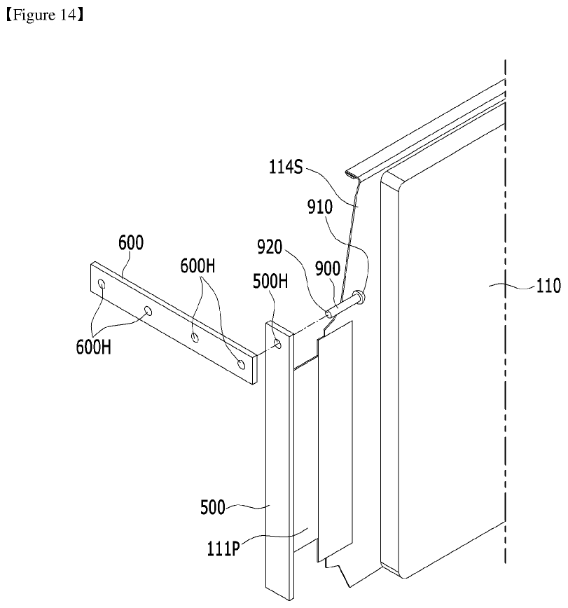

Since the battery cell 110 according to the present aspect has an integrated structure in which the busbar 500 is already connected to the battery cell 110, a bolt fastening structure using the connection busbar 600 is applied for electrical connection between battery cells 110. As compared to a conventional battery module in which weld-joining is performed between the electrode lead 11L and the busbar 40, the bolt fastening structure using the connection busbar 600 has the advantage that the degree of freedom can be increased in designing the battery module 100. This point will be described later with reference to FIG. 11. In addition, the bolt fastening structure is easier to rework than welding, and does not need to worry about loss due to defective welding between the electrode lead 11L and the busbar 40. Other examples of the mechanical fastening method will be described again with reference to FIGS. 14 to 19.

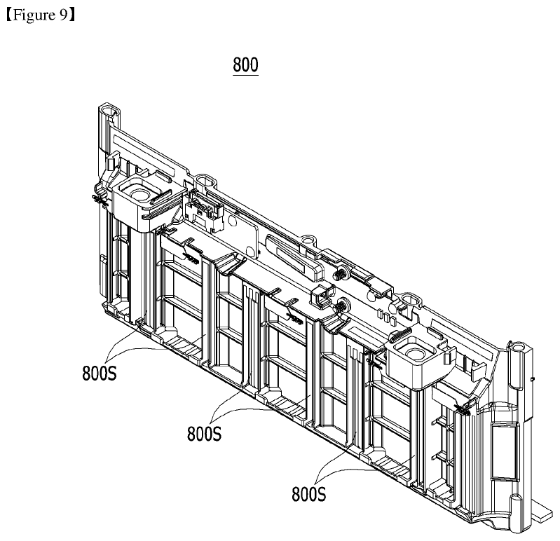

FIG. 9 is a perspective view illustrating a busbar frame according to an aspect of the present disclosure.

Referring to FIGS. 7 and 9 together, the battery module according to the present aspect may further include at least one busbar frame 800 arranged on one side or both sides of the battery cell stack 120. In FIG. 7, only the busbar 500 is illustrated for convenience of explanation, but the busbar frame 800 may be located between the battery cell stack 120 and the busbar 500.

Specifically, the busbars 500 are located on one side of the busbar frame 800, and the battery cell stack 120 may face the other surface of the busbar frame 800. The protrusions 111P and 112P of the battery cell 110 may pass through the slit 800S formed in the busbar frame 800.

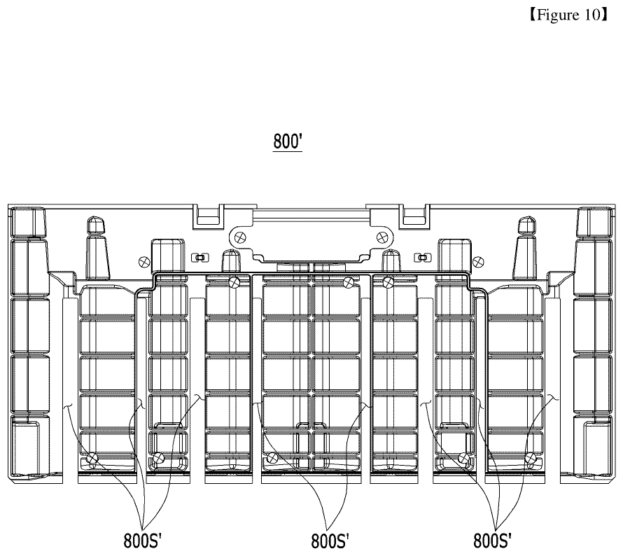

FIG. 10 is a front view illustrating a busbar frame according to another aspect of the present disclosure.

Referring to FIGS. 7 and 10 together, similarly to the busbar frame 800 of FIG. 9, the busbar frame 800′ according to another aspect of the present disclosure may be formed with a slit 800S′ through which the protrusions 111P and 112P of the battery cell 110 can pass. The busbars 500 are located on one side of such a busbar frame 800′, and the other side of the busbar frame 800′ may face the battery cell stack 120.

At this time, since the protrusions 111P and 112P according to the present aspect are already joined to the busbar 500, the slit 800S′ formed in the busbar frame 800′ according to the present aspect may be a slit that is opened toward the upper side or the lower side of the busbar frame 800, so that the protrusions 111P and 112P can be fitted into the slit 800S. As an example, FIG. 10 illustrates a slit 800S′ that is opened toward the lower side of the busbar frame 800. The protrusions 111P, which are already joined to the busbar 500, may be inserted into the slit 800S′ through the opened lower portion of the slit 800S′. Accordingly, the busbars 500 are located on one side of the busbar frame 800′, and the other side of the busbar frame 800′ may face the battery cell stack 120.

Meanwhile, the busbar frames 800 and 800′ may include an electrically insulating material. As an example, the busbar frames 800 and 800′ may include an electrically insulating plastic material. The busbar frames 800 and 800′ are members arranged to prevent short circuits from occurring between the busbars 500 and the battery cells 110.

Although not specifically illustrated, the busbar frame 800 may be equipped with a terminal busbar that functions as an external input/output terminal and a sensing assembly that transmits temperature and voltage information of the battery cell.

FIG. 11 is a front view schematically illustrating a busbar, a connection busbar, and a busbar frame according to an aspect of the present disclosure.

In FIG. 11, the appearance of the busbars 500 located on one side of the busbar frame 800 and that of the connection busbars 600a, 600b, and 600c that connect the busbars 500 are schematically illustrated.

The connection busbars 600a, 600b, and 600c according to the present aspect may have various shapes. As an example, the connection busbars 600a, 600b, and 600c may be a bar-shaped metal member or a metal member having a bending portion. The lengths of the connection busbars 600a and 600b, which are bar-shaped metal members, can be adjusted in various ways. Further, the connection busbar 600c can be freely provided with a bending portion.

In this manner, the busbars 500 can be connected by applying connection busbars 600a, 600b, and 600c having various shapes and sizes. Accordingly, the position and number of the battery cells having the busbar 500 can be freely set without limitation. That is, the mechanical fastening method using the connection busbar 600 has the advantage that the degree of freedom can be increased in designing the electrical connection method of the battery cells included in the battery module 100.

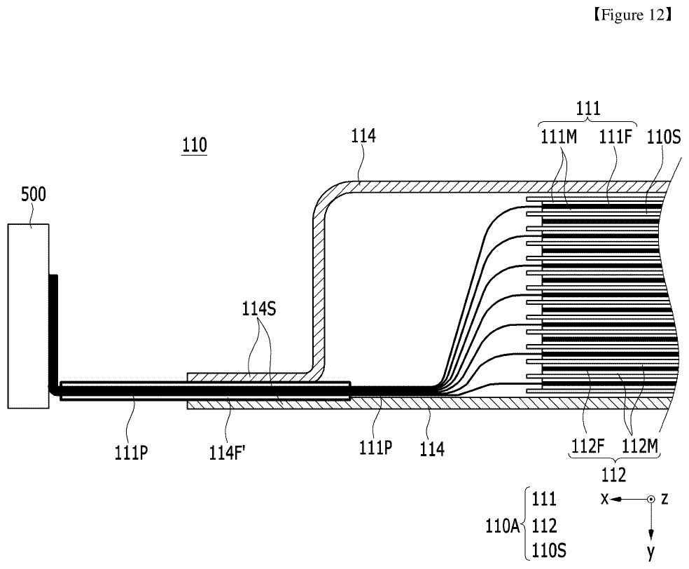

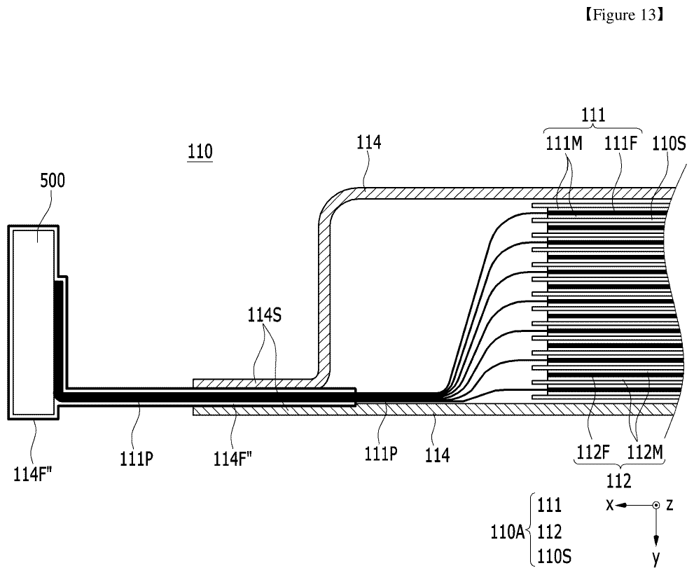

FIGS. 12 and 13 are cross-sectional views of the battery cells according to other aspects of the present disclosure, respectively.

First, referring to FIG. 12, similarly to the previously mentioned aspects, in battery cell 110, the electrode leads are removed, and a protrusion 111P extending from the electrode current collector 111F is joined to the busbar 500. In addition, in order to improve sealing performance and ensure electrical insulation, a film 114F′ surrounding the protrusions 111P and 112P may be interposed between the sealing portions 114S.

As compared to the removed electrode lead, the protrusion 111P extending from the electrode current collector 111F has relatively weak rigidity, and so it can be easily damaged by external impact or vibration. In order to supplement the rigidity of the protrusion 111P, the film 114F′ according to the present aspect may surround up to the area where the protrusion 111P is extended so as to be joined to the busbar 500. In other words, the film 114F′ according to the present aspect can surround up to the portion where the protrusion 111P is exposed to the outside of the sealing portion 114S of the pouch case 114.

Referring to FIG. 13, the film 114F″ according to another aspect of the present disclosure may surround not only an area where the protrusion 111P extends to be joined to the busbar 500, but also the portion where the protrusion 111P is joined to the busbar 500 and at least partial area of the busbar 500. This makes it possible to supplement the rigidity of not only the portion where the protrusion 111P is exposed to the outside of the seal portion 114S of the pouch case 114, but also the portion where the protrusion 111P and the busbar 500 are joined. Further, such a film 114F″ can increase electrical insulation by blocking the protrusion 111P or the busbar 500 from contacting other portions. Instead, the portion of the busbar 500 that is connected to the connection busbar 600 may not be covered by the film 114F″ in order to facilitate bolt fastening between the busbar 500 and the connection busbar 600.

Meanwhile, referring again to FIG. 4, the battery module 100 according to the present aspect may further include a module frame 200 in which the battery cell stack 120 is housed. The module frame 200 is a member that houses the battery cell stack 120 therein, and may include two side surface portions 210 and 220, an upper surface portion 230, and a lower surface portion 240. Further, the module frame 200 may be opened on both sides corresponding to the second direction and the opposite direction thereof. The battery cell stack 120 can be housed through either of the two opened sides. The module frame 200 may include a metal material having a predetermined strength to protect internal electrical components.

The module frame 200 illustrated in FIG. 4 may be a mono frame having a structure in which two side surface portions 210 and 220, an upper surface portion 230, and a lower surface portion 240 are integrated. Although not specifically illustrated, in other aspects of the present disclosure, a module frame in which a U-shaped frame and an upper plate are welded together is also possible. Looking at the stacking direction of the module frame 200 and the battery cells 110, the battery cells 110 may be stacked from one side surface portion 210 to the other side surface portion 220, so that one side of the battery cells 110, particularly one side of the cell body 113 (see FIG. 5), is parallel to one side of the side surface portions 210 and 220 of the module frame 200.

Meanwhile, the battery module 100 according to the present aspect may further include end plates 300 located on both opened sides of the module frame 200. The end plates 300 may be located so as to cover the battery cell stack 120 on both opened sides of the module frame 200. The edges of each end plate 300 may be joined to the corresponding edges of the module frame 200 by a welding method. The end plates 300 may include a metal material having a predetermined strength, and can protect the battery cell stack 120 and other electrical components from external impact. The busbar frame 800 (see FIG. 9) described above may be located between the end plate 300 and the battery cell stack 120.

The battery module 100 may further include a thermal resin layer 400 located between the battery cell stack 120 and the lower surface portion 240 of the module frame 200. One side of the battery cells 110 may be adhered to the thermal resin layer 400. Specifically, the thermal resin layer 400 may be formed by injecting or coating a thermal resin and then curing it. The thermal resin may include a thermally conductive adhesive material, and specifically may include at least one of a silicone material, a urethane material, or an acrylic material. The thermal resin may be in a liquid state when being coated, but may be cured after being coated, and adhere to one side of the battery cell 110. Thereby, the thermal resin layer 400 may serve to fix the battery cells 110. In addition, the thermal resin layer 400 has excellent heat conductivity, and can quickly transfer heat generated in the battery cell 110 to the lower side of the battery module.

Next, among the mechanical fastening methods of the present disclosure, other examples instead of the bolt fastening method will be described.

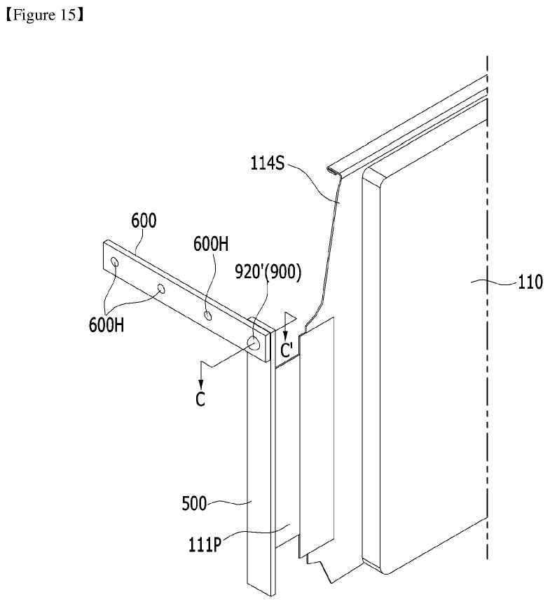

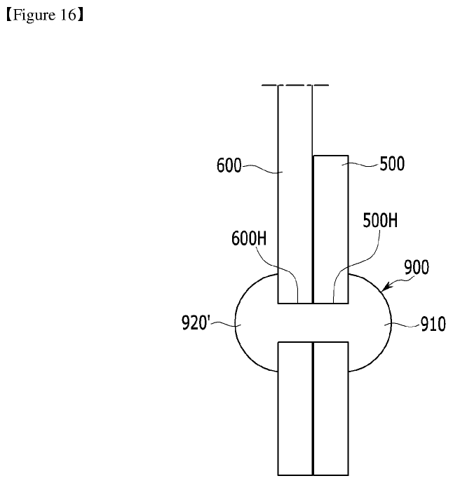

FIGS. 14 and 15 are perspective views illustrating a rivet fastening method among mechanical fastening methods according to aspects of the present disclosure. Specifically, FIG. 14 is a diagram illustrating before the rivet member is inserted, and FIG. 15 is a diagram illustrating after the rivet member is inserted and fastened. FIG. 16 is a cross-sectional view taken along the cutting line C-C′ of FIG. 15.

Referring to FIGS. 14 to 16, a rivet fastening may be applied to the mechanical fastening between busbars 500. An example of a rivet fastening method will be described below.

As previously described, the battery cell 110 may have a protrusion 111P that passes through the sealing portion 114S and is joined to the busbar 500. A through hole 500H may be formed in the busbar 500, and a rivet member 900 may fasten the through hole 500H of the busbar 500 and the through hole 600H of the connection busbar 600.

The rivet member 900 before being fastened has first and second ends 910 and 920 that have different diameters. The diameter of the first end 910 having a relatively large diameter is larger than the diameter of the through hole 500H of the busbar 500 and the diameter of the through hole 600H of the connection busbar 600. In addition, the diameter of the second end 920 having a relatively small diameter is smaller than the diameter of the through hole 500H of the busbar 500 and the diameter of the through hole 600H of the connection busbar 600. The second end 920 may pass through both the through hole 500H of the busbar 500 and the through hole 600H of the connection busbar 600.

After being passed through the holes, a force is applied to the second end 920 to deform the shape of the second end 920. The first end 910 is not deformed, but maintains the shape as it is. The appearance of the deformed second end 920′ is illustrated in FIGS. 15 and 16. The deformed second end 920′ may be deformed similarly to the first end 910. That is, the diameter of the deformed second end 920′ may be larger than the diameter of the through hole 500H of the busbar 500 and the diameter of the through hole 600H of the connection busbar 600. In the state where the rivet member 900 is passed through the through hole 500H of the busbar 500 and the through hole 600H of the connection busbar 600, rivet fastening may be completed by deforming the shape of the second end 920. The busbar 500 and the connection busbar 600 may be electrically connected to each other while being closely adhered and fixed by the rivet member 900.

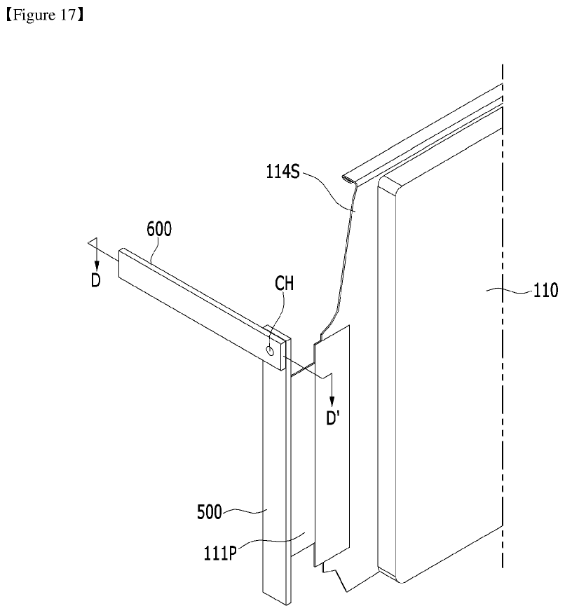

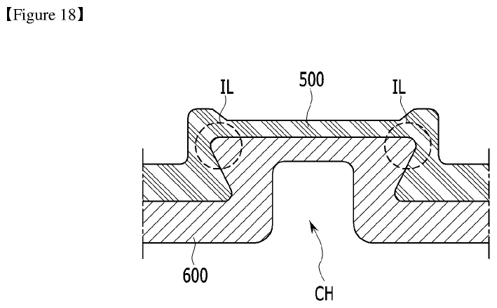

FIG. 17 is a perspective view illustrating the clinching fastening method among the mechanical fastening methods according to aspects of the present disclosure. FIG. 18 is a cross-sectional view taken along the cutting line D-D′ of FIG. 17.

Referring to FIGS. 17 and 18, the clinching fastening may be applied to the mechanical fastening between the busbars 500. An example of the clinching fastening will be described below.

As previously described, the battery cell 110 may have a protrusion 111P that passes through the sealing portion 114S and is joined to the busbar 500. The busbar 500 and the connection busbar 600 may be connected to each other by a clinching method.

Specifically, a press work can be performed using a punch and die in a state where the busbar 500 and the connection busbar 600 are in contact with each other. In the state where the busbar 500 and the connection busbar 600 are supported by the die, a clinching hole (CH) can be formed while the punch presses the overlapping portion of the busbar 500 and the connection busbar 600. At this time, an interlock structure (IL) can be formed depending on the shape of the die. The interlock structure (IL) can create a bonding force by utilizing the plastic deformation of materials and the flow in the opposite direction, whereby the busbar 500 and the connection busbar 600 can be electrically connected to each other while being closely adhered and fixed.

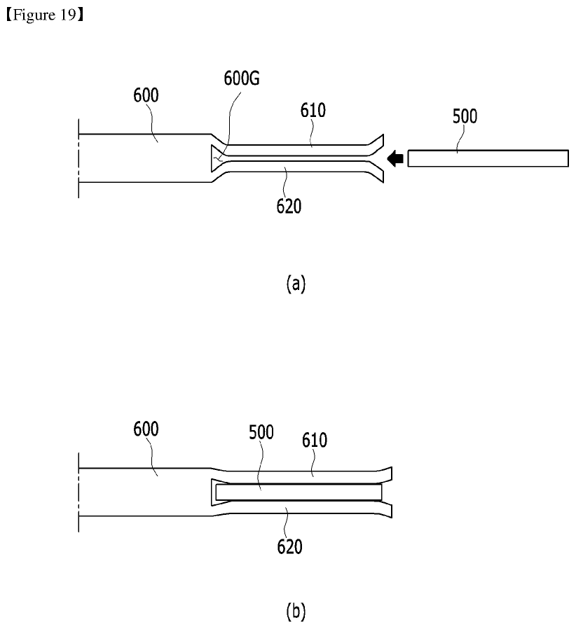

FIG. 19 (a) and (b) are cross-sectional views for explaining the fitting coupling among the mechanical fastening method according to aspects of the present disclosure. FIG. 19(a) illustrates the busbar and the connection busbar before they are coupled, and FIG. 19(b) illustrates the busbar and the connection busbar after they are coupled.

Referring to FIG. 19 (a) and (b), a fitting coupling may be applied to the mechanical fastening between the busbars 500. As an example, an insertion groove 600G may be formed in either the busbar 500 or the connection busbar 600, and the other of the busbar 500 and the connection busbar 600 may fit into this insertion groove 600G, so that the busbar 500 and the connection busbar 600 may be connected to each other. FIG. 19 (a) and (b) illustrates that an insertion groove 600G is formed in the connection busbar 600.

Further, an insertion groove 600G may be formed between the first portion 610 and the second portion 620 of the connection busbar 600, and the first portion 610 and the second portion 620 may have shapes bent toward each other. When the busbar 500 is inserted between the first portion 610 and the second portion 620, the first portion 610 and the second portion 620 function like a leaf spring, so that the busbar 500 can be fixed by the elastic force of the first portion 610 and the second portion 620. Thereby, the busbar 500 and the connection busbar 600 can be electrically connected to each other while being closely adhered and fixed. Although not specifically illustrated, an aspect of the present disclosure is also possible in which an insertion groove is formed in the busbar, and a connection busbar is inserted into the insertion groove of the busbar.

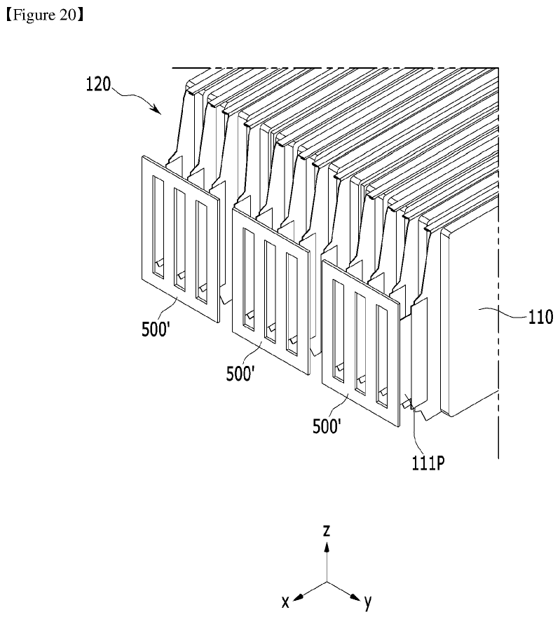

FIG. 20 is a partial perspective view which enlarges and illustrates the battery cell stack and busbar portion according to another aspect of the present disclosure.

Referring to FIG. 20, in the battery cell stack 120 according to another aspect of the present disclosure, the protrusions 111P of at least two battery cells 110 may be joined to one busbar 500′. The protrusion 111P protruding from the battery cell 110 is directly connected to the busbar 500′, wherein the protrusions 111P of a plurality of battery cells 110 may be joined to one busbar 500′. For this purpose, the busbar 500′ may be further extended along the direction in which the battery cells 110 are stacked, and the busbar 500′ may be formed with a slit. As an example, FIG. 20 illustrates that the protrusions 111P of four or five battery cells 110 are joined to one bus bar 500′. The plurality of battery cells 110 can be electrically connected simply by simply joining the plurality of protrusions 111P to one busbar 500′. That is, the present aspect has the advantage that contact resistance can be reduced because separate connections between busbars are not required.

The terms representing directions such as the front side, the rear side, the left side, the right side, the upper side, and the lower side have been used in the present aspect, but it is obvious to those skilled in the art that the terms used are provided simply for convenience of description, and may become different according to the position of an object, the position of an observer, or the like.

The one or more battery modules according to aspects of the present disclosure described above can be mounted together with various control and protection systems such as a BMS (battery management system), a BDU (battery disconnect unit), and a cooling system to form a battery pack.

The battery module or the battery pack can be applied to various devices. Specifically, it can be applied to vehicle means such as an electric bike, an electric vehicle, and a hybrid electric vehicle, or an ESS (Energy Storage System), but is not limited thereto, and can be applied to various devices capable of using a secondary battery.

Although the invention has been described in detail with reference to preferred aspects thereof, the scope of the present disclosure is not limited thereto, and various modifications and improvements can be made by those skilled in the art using the basic concepts of the present disclosure, which are defined in the appended claims, which also falls within the scope of the present disclosure.

### DESCRIPTION OF REFERENCE NUMERALS

100: battery module
110: battery cell
110A: electrode assembly
111, 112: electrode
111F, 112F: electrode current collector
111M, 112M: active material layer
111P, 112P: protrusion
114: pouch case
114S: sealing portion
120: battery cell stack
200: module frame
300: end plate
400: thermal resin layer
500: busbar
500H: through hole
600: connection busbar
600H: through hole
710: bolt member
720: nut member

1. A battery cell comprising:
an electrode assembly including a plurality of electrodes and a separator disposed therebetween; and
a pouch case having an outer peripheral side and accommodating the electrode assembly is therein,
wherein each of the plurality of electrodes includes an electrode current collector and an active material layer formed on at least one sides of the electrode current collector,
wherein the electrode current collector includes a protrusion protruding to an exterior of the pouch case, and
wherein a busbar is coupled to the protrusion.

2. The battery cell of claim 1, wherein:
the protrusion and the busbar are welded and joined.

3. The battery cell of claim 1, wherein:
the outer peripheral side of the pouch case is in a sealed state.

4. The battery cell of claim 1, further comprising:
a film surrounding the protrusion,
wherein the outer peripheral side of the pouch case defines a sealing portion, and
wherein the film surrounding the protrusion is interposed between the sealing portion and the protrusion.

5. The battery cell of claim 4, wherein:
the film surrounds up to a portion of the protrusion exposed to an exterior of the sealing portion.

6. The battery cell of claim 4, wherein:
the film surrounds a portion of the protrusion coupled to the busbar and at least a partial area of the busbar.

7. A battery module comprising:
a battery cell stack including a plurality of the battery cells of claim 1,
wherein a plurality of busbars are connected to each other by a mechanical fastening, so that an electric connection between the plurality of battery cells is performed.

8. The battery module of claim 7, wherein:
the mechanical fastening includes a bolt fastening, a rivet fastening, a clinching fastening, or a fitting coupling.

9. The battery module of claim 7, wherein:
the plurality of battery cells are stacked along a stacking direction so that at least one side surfaces of each of the plurality of battery cells faces each other.

10. The battery module of claim 7,
further comprising a connection busbar that connects the plurality of busbars.

11. The battery module of claim 10, wherein:
the connection busbar is connected to the plurality of busbars by the mechanical fastening.

12. The battery module of claim 11, wherein:
a through hole is defined in each of the plurality of busbars and the connection busbar, and
the bolt member extends through the through hole of each of the plurality of busbars and the through hole of the connection busbar and is fastened to a nut member.

13. The battery module of claim 11, wherein:
a through hole is defined in each of the plurality of busbars and the connection busbar, and
a rivet member extending through the through hole of each of the plurality of busbars and the through hole of the connection busbar, so as to couple each of the plurality of busbars and the connection busbar to each other.

14. The battery module of claim 11, wherein:
the plurality of busbars and the connection busbar are connected to each other by a clinching fastening.

15. The battery module of claim 11, wherein:
the plurality of busbars or the connection busbar include an insertion groove, and
wherein one of the plurality of busbars or the connection busbar are connected to each other while the other one of the plurality of busbars or the connection busbar is accommodated within the insertion groove.

16. The battery module of claim 11, wherein:
the connection busbar is a bar-shaped metal member or a metal member having a bending portion.

17. The battery module of claim 7, wherein:
the protrusion of each of the plurality of battery cells are joined to the plurality of busbars.

18. The battery module of claim 7, wherein:
at least one busbar frame is arranged on one side of the battery cell stack, and
the busbar frame is located between the busbar and the battery cell stack.
